(19) United States
(12) Patent Application Publication
(10) Pub. No.: US 2008/0230575 A1
(43) Pub. Date: Sep. 25, 2008

(54) HANGER FOR APPARELS AND OTHER ITEMS MADE OF CORRUGATED BOARDS

(76) Inventor: Joseph Nazari, Glendale, CA (US)

Correspondence Address: YING CHEN;Chen Yoshimura LLP, 255 S. GRAND AVE., # 215, LOS ANGELES, CA, 90012, US

(21) Appl. No.: 12/131,835

(22) Filed: Jun. 2, 2008

Related U.S. Application Data
(63) Continuation-in-part of application No. 11/374,769, filed on Mar. 14, 2006.
(60) Provisional application No. 60/711,024, filed on Aug. 24, 2005.

(51) Int. Cl. B32B 3/02; B32B 37/10; A47G 25/36; B26D 7/08; B26D 7/10

(52) U.S. Cl. 223/87; 428/83; 156/220; 83/14

(57) ABSTRACT

An item such as a hanger for apparels made from corrugated boards is described. The item is made from one, two or more sheets of stacked corrugated boards. An adhesive material is applied to adhere the sheets together. The corrugations in the board(s) in the peripheral areas of the item are crushed to reduce the air gap in the corrugations. Also described are manufacturing methods for making such an item.

This application is a continuation-in-part of U.S. patent application Ser. No. 11/374,769, filed Mar. 14, 2006, now pending, which is a continuation-in-part of U.S. Provisional Appl. No. 60/711,024, filed Aug. 24, 2005, both of which are herein incorporated by reference in their entirety.

### BACKGROUND OF THE INVENTION

1. Field of the Invention

This invention relates to items such as hangers for apparels, display board for stores, etc. made from corrugated boards.

2. Description of the Related Art

Hangers for apparels have traditionally been made from plastic, metal or wood materials. Recently, there have been disclosed clothes hangers made from corrugated boards. For example, U.S. Pat. No. 7,267,252, issued Sep. 11, 2007, entitled “Corrugated clothes hanger structure,” describes a clothes hanger construction of folded corrugated paper with two interconnected neck members. The neck members are intertwined via coordinated opposing slots in the hook portion of a clothes hanger having two shoulder portions. The structure is cut from a single piece of corrugated cardboard and folded along a single fold line to form the hanger. U.S. Patent Appl. Pub. No. 2004/0031825, published Feb. 19, 2004, entitled “Garment hanger,” describes a garment hanger comprising two parts or elements which are hinged together so that they can be folded from a first relatively flat or opened out configuration to a second configuration in which the two parts or elements are adjacent and facing each other, at least one of the parts including first means by which the hanger can depend from a support when in its second configuration, the two parts providing second means from which a garment can be hung. The two parts or elements are preferably of a flexible stiff sheet material such as a corrugated material, e.g. corrugated cardboard.

### SUMMARY OF THE INVENTION

The present invention provides an improved hanger for apparels made of one, two or more sheets of stacked corrugated cardboards, where the corrugations of the cardboard sheets at the peripheral areas of the hangers are crushed to result in reduced air gaps in the corrugations.

The present invention also provides other useful items made by the above technique, such as display boards used in stores for displaying promotional information, dummy boards used in stores for selling certain items, other items used in product packaging, etc.

An object of the present invention is to provide a more environmentally friendly way of manufacturing hangers for apparels and other items.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides an item which comprises a stack of one or more shaped sheets of corrugated boards, wherein corrugations of the sheets of corrugated board are crushed in a peripheral area of the boards with reduced air gaps in the corrugations. In one embodiment, the stack includes two or more shaped sheets of corrugated boards stacked together, and an adhesive material (heat-sensitive or pressure-sensitive) is applied between adjacent sheets of corrugated boards. In another embodiment, the stack includes a single shaped sheet of corrugated boards.

In one particular example, the sheets of corrugated boards are shaped into a hanger for apparels.

In another aspect, the present invention provides a method for making an item which includes: (a) stacking two or more sheets of corrugated boards together; (b) applying an adhesive material between adjacent sheets of corrugated boards; (c) applying a pressure to the stacked corrugated boards in band shaped areas containing an outline of the item to crush corrugations in the boards to reduce air gaps in the corrugations in the band shaped areas; (d) sealing the two or more sheets of corrugated boards with the adhesive material; and (e) cutting the boards along the outline to form the item. In one embodiment, the adhesive is a heat-sensitive adhesive, and steps (c) and (d) are performed concurrently using a heated press. In another embodiment, the adhesive is a pressure-sensitive adhesive, and steps (c) and (d) are performed concurrently using a press. In another embodiment, the adhesive is a heat-sensitive or pressure-sensitive adhesive, and steps (c), (d) and (e) are performed concurrently using a cutting die, wherein the cutting die has a cutting edge and a shoulder portion adjacent to the cutting edge, wherein a height of the shoulder portion above an end point of the cutting edge is smaller than a thickness of the stacked boards being cut.

In another aspect, the present invention provides a method for making an item which includes: (a) providing a sheet of corrugated board; (b) applying a pressure to the corrugated board in band shaped areas containing an outline of the item to crush corrugations in the board to reduce air gaps in the corrugations in the band shaped areas; and (c) cutting the board along the outline to form the item.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a perspective view illustrating a display pack according to an embodiment of the present invention.

FIGS. 2(a) and 2(b) schematically illustrate cross-sectional views of the display pack of FIG. 1 along the line 2-2 with platens of a sealing press.

FIG. 3 schematically illustrates parts of a sealing press used to seal a package according to an embodiment of the present invention.

FIG. 4(a)-4(c) show examples of the shapes of a hanger for apparel.

FIG. 5 is a partial cross-sectional view of the hanger in FIG. 4(a).

FIG. 6 illustrates multiple hangers being cut from large corrugated boards.

FIG. 7 illustrates a press with slanted contact surfaces used in a method of manufacturing hangers from corrugated boards.

FIG. 8 illustrates a cutting die used in a method of manufacturing hangers from corrugated boards.

### DETAILED DESCRIPTION OF THE PREFERRED EMBODIMENTS

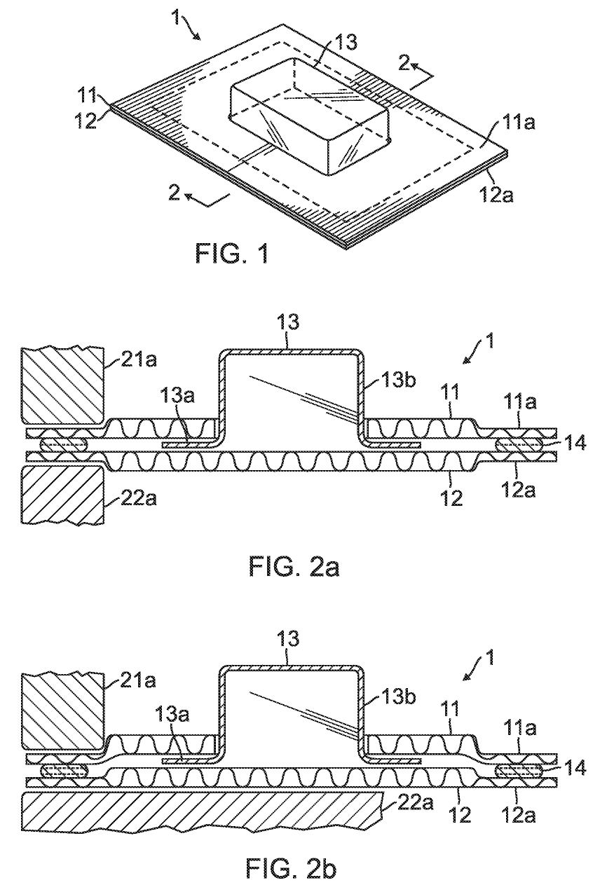

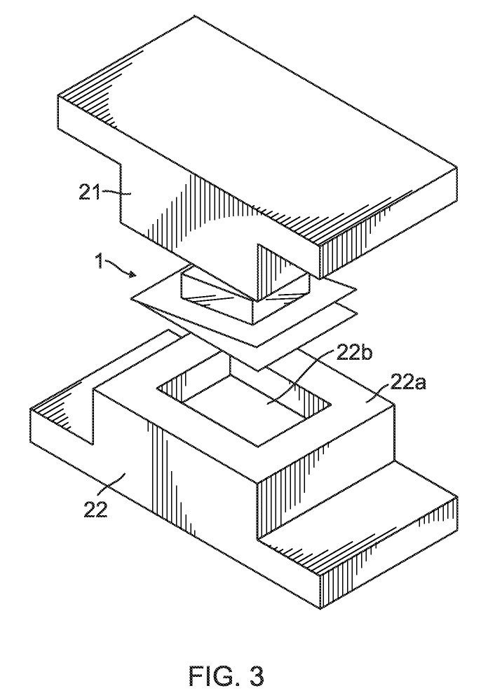

FIG. 1 shows a display pack according to an embodiment of the present invention. FIGS. 2(a) and 2(b) are cross-sectional views of the display pack of FIG. 1 along the line 2-2 (the differences between FIGS. 2(a) and 2(b) will be explained later). As shown in FIGS. 1, 2(a) and 2(b), the package 1 is made of two sheets of corrugated cardboard 11 and 12 and a plastic container 13 (preferably made of a clear plastic material such as PET) having a flat insertion portion 13a and a chamber portion 13b. The insertion portion is sandwiched between the two cardboard sheets 11 and 12, and the chamber portion 13b protrudes from the plane of the cardboard sheets via a cut on one cardboard sheet 11 and is used to hold the product inside. The front and back sides of the package may be printed with product information and other information. The information may be printed directly on the cardboard, or printed on a litho sheet which is then laminated onto the cardboard. One to six colors can be printed. The two corrugated cardboard sheets 11 and 12 are adhered together at the periphery of the package by a heat-sensitive adhesive 14 to seal the package. The heat-sensitive adhesive is preferably pre-applied to the inner sides of one or (preferably) both cardboard sheets 11 and 12 prior to the sealing operation, but it may also be applied during the sealing operation. The adhesive may be applied to the entire sheet, or a periphery, or any desired areas of the sheet. In one embodiment, the cardboard sheets 11 and 12 are formed of one cardboard sheet folded over, the cardboard sheet being pre-coated with an adhesive on the entire surface.

To seal the package, the peripheral areas 11a, 12a of the two overlaying cardboard sheets are subject to a sufficient amount of pressure to crush the corrugations inside the cardboard sheets and flatten them in that area. Heat is applied, either simultaneously with or subsequent to the application of pressure, to the outer side of either one or both cardboard sheets in the peripheral area. Because the corrugations inside the cardboard are crushed and the air gaps are substantially eliminated, the crushed cardboard becomes a better heat conductor. Sufficient heat can be conducted from the outer side to the inner side where the heat-sensitive adhesive has been applied to activate the adhesive and seal the package. In one preferred embodiment, the width of the crushed peripheral areas is approximately 0.5 inches. Any suitable sealing width may be used.

Many types of sealer machines may be used to carry out the sealing process. One example is a sealer machine with a heated sealing press. As shown in FIG. 3 (perspective view), the sealing press has an upper platen 21 and a lower platen 22. The lower platen 22 is show to have a rim 22a with a heated surface, a recessed central portion 23 that may accommodate the protrusions 13b of the package being sealed. The upper platen 21 similarly has a heated rim 21a and a recessed central portion (not shown). The rims have a width determined by the desired width of the crushed peripheral areas of the finished package. Alternative configurations of the sealing press may be used. For example, one of the platens may have a flat surface without a recess, or have a rim wider than the rim of the other platen. If both the upper and lower platens have rims of similar widths, the crushed peripheral areas of the cardboard sheets may appear depressed on both sides (see FIG. 2(a)). If one platen is flat or has a rim wider than the rim of the other platen, the crushed peripheral areas of the cardboard sheets may appear depressed only on the side of the narrower rim (see FIG. 2(b)). In the platen configuration of FIG. 2(a), one or both rim portions 21a and 22a may be heated. In the configuration of FIG. 2(b), preferably only the narrower rim 21a is heated because it may be undesirable for areas other than the sealed peripheral areas to be heated. Heating from both sides may be more desirable as it reduces the heating time and speeds up the sealing operation.

Preferably, the force or pressure applied by the platens is such that the cardboard sheets are crushed to up to approximately 50% of their original thickness. Generally speaking, within certain limits, higher pressure results in thinner crushed cardboard sheets, which in turn results in increased heat transfer rate and therefore reduced heat application time required to properly activate the adhesive. The optimum pressure may also depend on the type of the cardboard used. The temperature of the heated surface may be approximately from 100 to 500 degrees F. Those of ordinary skill in the art will be able to find acceptable or optimum pressure, temperature and process time conditions for the particular cardboard used without undue experimentation.

In one particular example, the package uses two sheets of 200 lb test E-flute cardboard coated with a heat sensitive blister card coating as an adhesive, has a size of 10 inches by 15 inches and a sealed width of 0.5 inches. The sealing press has a rim on both platens and both surfaces are heated to a temperature of 300 degrees F. The force on the platens is 25 tons. The pressure and heat was applied simultaneously for 3 seconds.

The package in FIG. 1 is shown to be sealed with the adhesive on all four sides. Alternatively, instead of sealing around the entire periphery with the heat-sensitive adhesive, the package may be sealed in selected peripheral areas only. In particular, the two cardboard sheets 11 and 12 may be made of one board and folded once in the middle, and the side of the package corresponding to the fold line may not need to be sealed with the adhesive (although it is preferable to seal it as well). In such cases, the platens of the sealing press may be constructed so that heat and pressure are only applied to the areas where seals are to be formed.

The packaging technique according to embodiments of the present invention has many advantages. The packages are more secure and harder to tear from the edge and the center than packages made by conventional methods. They are also aesthetically more appealing in that the corrugations of the cardboard sheets are less visible when viewed from the side edges (e.g. the bottom side) due to the crushing. These packages according are more environmentally friendly because it uses primarily cardboards which is made of post-consumer recycled materials. The sealing technique is also faster than in conventional techniques. Although the packaging techniques in the above-described embodiments are most advantageous when used in combination with a heat-sensitive adhesive, the crushing technique described above may also be applied when a regular, non-heat-sensitive adhesive is used.

In addition to display packs, the technique described above can be used to make other items, such as hangers for apparels, display boards used in stores for displaying promotional information, dummy boards used in stores for selling certain items, other items used in product packaging, etc. These items are generally made of a stack of one, two or more corrugated cardboards (as used in this disclosure, a “stack” can include a single board). The boards are adhered together (in the case of two or more boards) by an adhesive. A peripheral area of the items is crushed by applying a pressure to result in reduced air gaps in the corrugations in those areas.

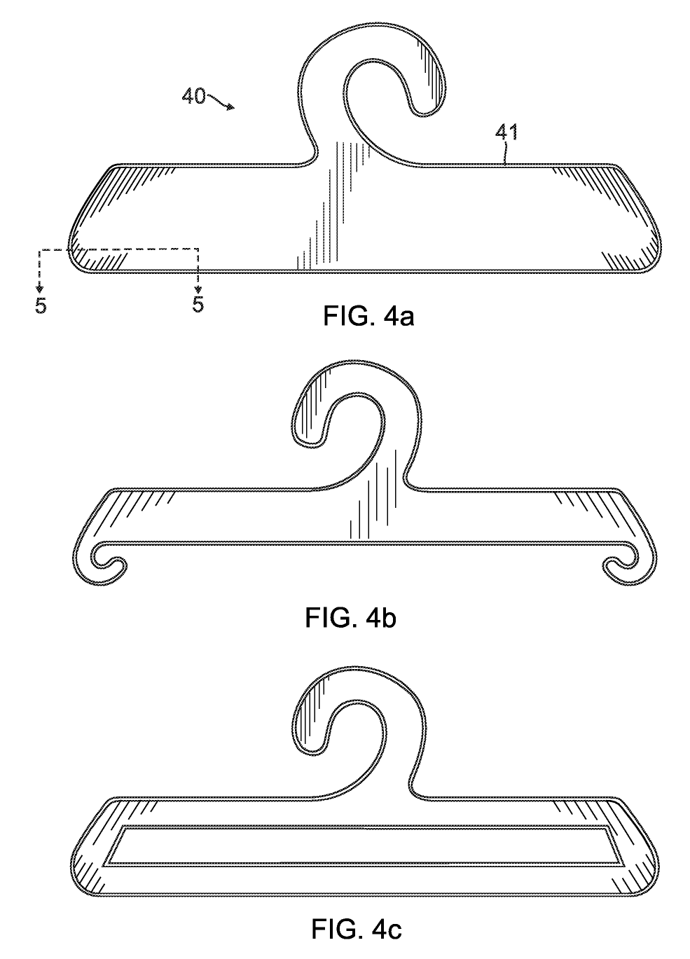

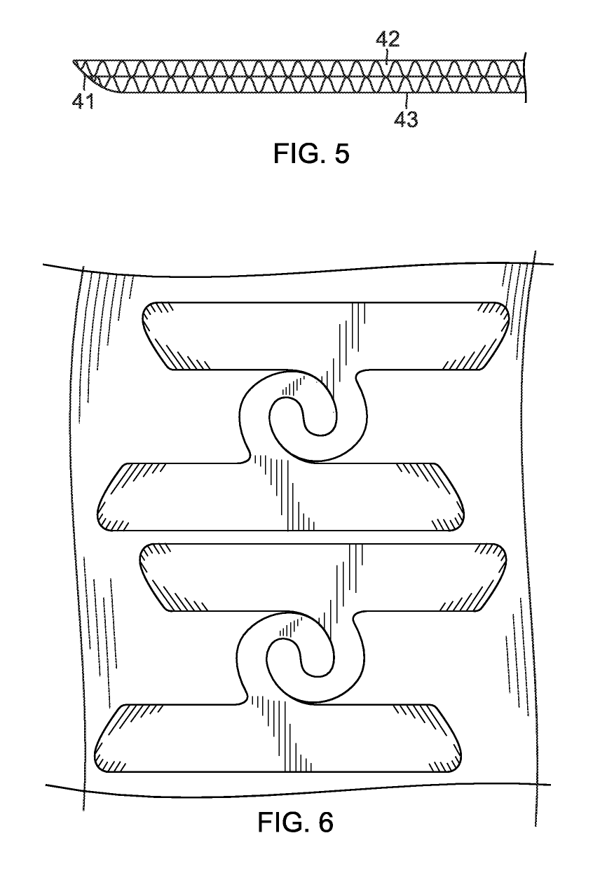

A hanger for apparel (clothes hanger) is described as an example of the various items that can be made using such techniques. FIGS. 4(a), 4(b) and 4(c) show three exemplary shapes of clothes hangers. The hanger 40 is constructed of one, two or more sheets of corrugated boards. If two or more boards are used, an adhesive material is applied between adjacent boards to adhere the boards together. A peripheral area 41 of the hanger is crushed with reduced air gaps in the corrugations. FIG. 5 is a partial cross-sectional view taking along the line 5-5 in FIG. 4(a). As schematically shown in FIG. 5, the hanger 40 is formed of two sheets of corrugated boards 42 and 43, and the peripheral area (the edge) 41 is crushed so that the air gap in the corrugations is reduced. When two or more sheets of corrugated boards are used to construct the hanger, an adhesive (not shown in FIG. 5) is applied between the boards to adhere them together. Alternatively, a combination of corrugated board(s) and non-corrugated boards such as paper boards can be used to construct the hangers.

The corrugated board construction provides sufficient strength for the clothes hanger for its intended use. According to tests conducted by the inventor, a clothes hanger made of a single F flute corrugated board ( 1/32 inches thick) has a holding capacity of approximately 6-7 lbs. A hanger made of a single E flute corrugated board ( 1/16 inches thick) has a holding capacity of approximately 10 lbs. The holding capacities for a hanger made of double F flute boards and double E flute boards are approximately 10 and 26 lbs, respectively. Optionally, a litho laminate may be added on one or both sides of the hanger, which further increase its strength.

Several methods may be used to manufacture the corrugated board clothes hangers. The first method is similar to the method described above for making the display packaging. Corrugated cardboards are cut into the shape of a hanger. Two or more shaped boards are stacked with an adhesive applied between the boards. Alternatively, two or more corrugated boards may be stacked with an adhesive applied between the boards, and the stack is cut into the shape of a hanger. Alternatively, one sheet of corrugated board may be cut into an appropriate shape and folded over to create a stack of two boards having the shape of a hanger, and an adhesive is applied on the inside of the folded sheets. The adhesive may be applied to only a peripheral area of the hanger, or to a peripheral area and selected interior areas, or to the entire area of the hanger. Then, the shaped stack of corrugated boards is pressed around the peripheral area using a press (sometimes also referred to as a sealing press) to crush the corrugations of the boards in that area, in a manner similar to that shown in FIG. 3. The upper, lower, or both platens of the press have a shape corresponding to the peripheral shape of the hangers (refer to FIG. 2(a)—both platens are shaped, and FIG. 2(b)—the lower platen is not shaped).

In one particular implementation of the first method, the adhesive is a heat-sensitive adhesive and is applied between the boards in the peripheral area. A heated press is used where the platens of the press are heated, and the pressing step activates the heat-sensitive adhesive in the peripheral area to adhere the two or more corrugated boards together. As explained earlier in connection with the packaging embodiments, the crushing of the corrugations reduces the air gaps within the corrugated boards to allow heat to be properly conducted from the sealing press to the adhesive material. Using this implementation, the crushing of the corrugations and the adhering of the two or more boards are accomplished in a single step.

In another implementation of the first method, the adhesive is a pressure-sensitive adhesive, such as a pressure sensitive wax. Such a material is activated and becomes adhesive when an appropriate pressure is applied to it. The pressure-sensitive adhesive is applied between the boards in the peripheral area. The pressing step activates the pressure-sensitive adhesive to adhere the two or more corrugated boards together. This implementation can also accomplish the crushing of the corrugations and the adhering of the two or more boards in a single pressing step. A pressure sensitive adhesive does not require the platens to be heated during pressing, thereby simplifying the structure of the press.

Heat-sensitive and pressure-sensitive adhesives have their relative advantages and disadvantages. The heat-sensitive adhesive requires a heated press while the pressure-sensitive adhesive does not. The pressure-sensitive adhesive, on the other hand, may be more costly to use because a protective sheet (e.g. waxed paper) may be required to protect the adhesive. In addition, some pressure-sensitive adhesives may be too sensitive and cannot be stacked without the protective paper. Thus, a presently preferred embodiment uses a heat-sensitive adhesive, but a pressure-sensitive adhesive is also within the scope of this invention.

Of course, non-heat-sensitive and non-pressure sensitive adhesives may also be used. When such an adhesive is used, the adhesive is applied, and the boards are stacked within an appropriate time period from the application of the adhesive.

A second method of manufacturing the hangers is a variation to the first method, whereby multiple hangers are simultaneously formed from large sheets of corrugated boards. Two or more large sheets of corrugated boards are stacked, with an adhesive applied between the boars. The boards may be, for example, 40 by 48 inches in size. The adhesive may be applied only in areas corresponding to the peripheral areas of the hangers that will be cut from the boards, or it may be applied in the entire area of the hangers to be cut, or the entire area of the boards. Then, the stacked boards are cut along the outlines of multiple hangers, but the cut is an incomplete cut whereby short segments along the outlines are uncut. As a result, the hangers remain in the stack of boards. The stack is transferred to a press, where the platen(s) of the press have the same shape as the outline of the hangers. The peripheral areas of the hangers are pressed using the press to crush the corrugations of the board. If the adhesive is a heat-sensitive or pressure-sensitive adhesive, the pressing step also activates the adhesive (either by pressure or by heat) to adhere the boards together. Afterwards, the formed hangers can be easily pushed out of the boards.

In the second method, the outlines of the hangers on the board may be arranges in a nested fashion so that more hangers can be formed from each stack of boards, as shown in FIG. 6. In such a case, the platens may be suitably shaped to press multiple hangers simultaneously.

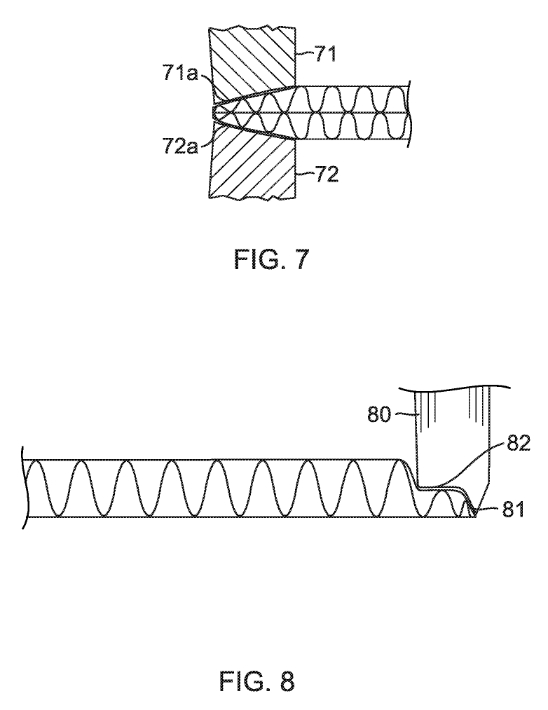

In the first and second methods, the platens of the press may be made to have a slanted or curved contact surface so that the boards are pressed thinner toward the edge than toward the interior of the hanger. As shown in FIG. 7, which is a partial cross-sectional view of the press and two boards being pressed, the contact surfaces 71a, 72a of the upper and lower platens 71, 72 are shown as being slanted.

A third method of manufacturing the hangers uses a cutting tool with a special cutting die. FIG. 8 is a cross-sectional view of the cutting die. The cutting die 80 has a sharp cutting edge 81 as in a conventional cutting die, and a shoulder portion 82 adjacent to the cutting edge 81. The cutting die is moved relative to the stack of boards along the outline of the hangers to cut the hangers out of the boards. The height of the shoulder portion 82 above the end point of the cutting edge 81 is designed to be smaller than the thickness of the stack of un-crushed boards making up the hanger. For example, the height may be a half of the thickness of the stack of un-crushed boards. When the cutting die 80 is pressed on the stack of boards to cut the hangers, the shoulder portion 82 is located on the side of the cutting edge 81 toward the interior of the hangers, and presses on the edge of the boards to crush the corrugations in a peripheral area of the boards. As a result, cutting and crushing of the corrugations are accomplished in a single step. The shoulder portion 82 may be slightly slanted (similar to the platen surfaces 71a, 72a in the first and second embodiments shown in FIG. 7) so that the boards are pressed thinner toward the edge of the hangers than toward the interior of the hanger. The cutting die 80 may be heated if a heat-sensitive adhesive is used, so that cutting, crushing of the corrugation and activation of the adhesive can be accomplished in a single step.

For the above two manufacturing methods, the corrugated boards may be pre-applied with the adhesive on their surfaces during manufacturing of the boards. Multiple corrugated boards may also be pre-stacked together with an adhesive applied between the boards. Using such pre-stacked boards, cutting and pressing steps, either as separate steps or as a single combined step, are carried out to form items of desired shapes.

The various manufacturing methods are described above using as examples a stack of two or more corrugated boards to cut the hangers. Hangers may also be made from a single layer of corrugated board. The same manufacturing methods described above can be used, except that no adhesive is needed on the surface of the boards.

In an alternative embodiment, an adhesive material such as a pressure sensitive wax or a heat sensitive adhesive is applied inside the corrugated board between the two flat sheets and the corrugations. This may be accomplished by adding the adhesive during the manufacturing of the corrugated boards. When the peripheral area of the hangers is pressed to crush the corrugations, the adhesive material is activated (either by the pressure or by the heat using a heated press), and the corrugations and the two flat sheets of the board are adhered together in the peripheral areas of the hangers. This further increases the tear-resistance of the hangers.

Corrugates boards typically use an adhesive material to adhere the corrugations to the two flat sheets that sandwich the corrugations. In many currently commercially available corrugated boards, the adhesive material used within the board is a corn starch based adhesive. The inventor of the current invention discovered that such cornstarch-based adhesive can be activated or re-activated (i.e. become sticky again) by heat. One possible explanation of the re-activation mechanism is that moisture which naturally exists in the boards is evaporated under heat, and the evaporated moisture re-activates the adhesive. Thus, such currently available corrugated boards can be used without modification to make single-board hangers using a heated press or heated cutting die, with the result that the existing adhesive material is re-activated during pressing or cutting-pressing to adhere the corrugations and the two flat sheets of the board together in the peripheral areas of the hanger.

The hangers described above are optionally printed with desired colors and patterns to enhance their appeal. The corrugated boards may be directly printed on, or a litho laminate with printed patterns may be adhered to the corrugated boards. As mentioned earlier, the laminate will also increase the holding capacity of the hanger.

It will be apparent to those skilled in the art that various modification and variations can be made in the method and manufactured product of the present invention without departing from the spirit or scope of the invention. Thus, it is intended that the present invention cover modifications and variations that come within the scope of the appended claims and their equivalents.

What is claimed is:

1. An item comprising:
a stack of one or more shaped sheets of corrugated boards,
wherein corrugations of the sheets of corrugated board are crushed in a peripheral area of the boards with reduced air gaps in the corrugations.

2. The item of claim 1, wherein the sheets of corrugated boards are shaped into a hanger for apparels.

3. The item of claim 1, wherein the stack includes two or more shaped sheets of corrugated boards stacked together, the item further comprising:
an adhesive material between adjacent sheets of corrugated boards.

4. The item of claim 1, wherein the adhesive material is a heat-sensitive adhesive.

5. The item of claim 1, wherein the adhesive material is a pressure-sensitive adhesive.

6. The item of claim 1, wherein the stack includes a single shaped sheet of corrugated boards.

7. A method for making an item, comprising:
(a) stacking two or more sheets of corrugated boards together;
(b) applying an adhesive material between adjacent sheets of corrugated boards;
(c) applying a pressure to the stacked corrugated boards in band shaped areas containing an outline of the item to crush corrugations in the boards to reduce air gaps in the corrugations in the band shaped areas;
(d) sealing the two or more sheets of corrugated boards with the adhesive material; and
(e) cutting the boards along the outline to form the item.

8. The method of claim 7, wherein the outline of the item defines a hanger for apparel.

9. The method of claim 7, wherein the adhesive is a heat-sensitive adhesive, and wherein steps (c) and (d) are performed concurrently using a heated press.

10. The method of claim 7, wherein the adhesive is a pressure-sensitive adhesive, and wherein steps (c) and (d) are performed concurrently using a press.

11. The method of claim 7, wherein the adhesive is a heat-sensitive adhesive, and wherein steps (c), (d) and (e) are performed concurrently using a heated cutting die, wherein the cutting die has a cutting edge and a shoulder portion adjacent to the cutting edge, wherein a height of the shoulder portion above an end point of the cutting edge is smaller than a thickness of the stacked boards being cut.

12. The method of claim 7, wherein the adhesive is a pressure-sensitive adhesive, and wherein steps (c), (d) and (e) are performed concurrently using a cutting die,
wherein the cutting die has a cutting edge and a shoulder portion adjacent to the cutting edge, wherein a height of the shoulder portion above an end point of the cutting edge is smaller than a thickness of the stacked boards being cut.

13. A method for making an item, comprising:
(a) providing a sheet of corrugated board;
(b) applying a pressure to the corrugated board in band shaped areas containing an outline of the item to crush corrugations in the board to reduce air gaps in the corrugations in the band shaped areas; and
(c) cutting the board along the outline to form the item.

14. The method of claim 13, wherein the outline of the item defines a hanger for apparel.

15. The method of claim 13, wherein steps (b) and (c) are performed concurrently using a cutting die,
wherein the cutting die has a cutting edge and a shoulder portion adjacent to the cutting edge, wherein a height of the shoulder portion above an end point of the cutting edge is smaller than a thickness of the stacked boards being cut.

16. The method of claim 15, wherein the cutting die is heated.
